(19) United States
(12) Patent Application Publication
(10) Pub. No.: US 2023/0116273 A1
(43) Pub. Date: Apr. 13, 2023

(54) PREVENTION OF INADVERTENT PASSWORD DISCLOSURE

(71) Applicant: Citrix Systems, Inc., Fort Lauderdale, FL (US)

(72) Inventors: Qiming Li, Nanjing (CN); Dai Li, Nanjing (CN); Zhenxing Liu, Nanjing (CN)

(21) Appl. No.: 17/529,369

(22) Filed: Nov. 18, 2021

Related U.S. Application Data
(63) Continuation of application No. PCT/CN2021/123493, filed on Oct. 13, 2021.

(51) Int. Cl. G06F 21/62; G06F 3/0481

(52) U.S. Cl. CPC G06F 21/6245; G06F 3/0481

(57) ABSTRACT

In one aspect, an example methodology implementing the disclosed techniques includes, by a computing device, determining whether a user interface element having focus is a secure input and, responsive to a determination that the user interface element is a secure input, preventing the focus from changing away from the user interface element. The method also includes, by the computing device, responsive to a determination that the user interface element is a secure input, allowing the focus to change away from the user interface element in response to a determination that an input to the user interface element is complete. The method may further include, by the computing device, responsive to a determination that the user interface element is not a secure input, allowing the focus to be moved to another user interface element.

### CROSS REFERENCE TO RELATED APPLICATIONS

This application is a continuation of and claims the benefit of PCT Patent Application No. PCT/CN2021/123493 filed on Oct. 13, 2021 in the English language in the State Intellectual Property Office and designating the United States, the contents of which are hereby incorporated herein by reference in its entirety.

### BACKGROUND

Due at least in part to the growth of high-speed networks such as the Internet, increasing numbers of services and applications are being made available to users. Many of these services and applications require some sort of user authentication to confirm the identity of a user. For example, when attempting to access an application, a user is often presented with a login prompt that requires the user to authenticate him/herself by providing credentials, such as a username and password, in order to access the application. If a user enters a correct username and password, the user is granted access to the application. Conversely, if the user enters an incorrect username and/or password, the user is denied access to the application.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

As noted above, users often find themselves having to enter a password to access their applications. If the user has multiple applications or application windows open when entering a password or other types of secret, there is a risk that the password or a portion thereof may be entered into the wrong application/window. This can result in an inadvertent disclosure of the password or other secret. One way this can happen is due to a change in keyboard focus. Keyboard focus (or more simply “focus”) refers to the user interface (UI) element which is currently selected to receive input such as keyboard input. For example, when a user is entering a password on a computing device to access an application, the UI element that is receiving the password has focus. Such a UI element is generally referred to herein as a “secure input” with a password field being one example of a secure input. When a new application window is opened on the computing device, the focus may change to the newly opened window (e.g., automatically by the operating system). So, if a new window opens when the user is about to enter a password, the user may not realize that the focus has been moved to the new window and thus may accidently enter the password in the new window. This can result in the user's password being leaked or otherwise compromised. For example, the newly opened application window may cause the password to be displayed on a screen in plaintext or to be transmitted to an untrusted party. Embodiments of the present disclosure provide solutions to these and other technical problems described herein.

In accordance with one example embodiment provided to illustrate the broader concepts, systems, and techniques described herein, a method may include, by a computing device, determining whether a user interface element having focus is a secure input and, responsive to a determination that the user interface element is a secure input, preventing the focus from changing away from the user interface element. The method may also include, by the computing device, responsive to a determination that the user interface element is a secure input, allowing the focus to change away from the user interface element in response to a determination that an input to the user interface element is complete.

According to another illustrative embodiment provided to illustrate the broader concepts described herein, a system includes a memory and one or more processors in communication with the memory. The processor may be configured to determine whether a user interface element having focus is a secure input and, responsive to a determination that the user interface element is a secure input, prevent the focus from changing away from the user interface element. The processor may be further configured to, responsive to a determination that the user interface element is a secure input, allow the focus to change away from the user interface element in response to a determination that an input to the user interface element is complete.

According to another illustrative embodiment provided to illustrate the broader concepts described herein, a method may include, by a computing device, identifying one or more applications executing on the computing device, identifying one or more user interface elements associated with the identified one or more applications which are secure inputs, and emphasizing the identified one or more user interface elements.

According to another illustrative embodiment provided to illustrate the broader concepts described herein, a computing device includes a memory and one or more processors in communication with the memory. The processor may be configured to identify one or more applications executing on the computing device, identify one or more user interface elements associated with the identified one or more applications which are secure inputs, and emphasize the identified one or more user interface elements.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIGS. 4A and 4B are diagrams that collectively illustrate how focus can inadvertently change away from a secure input.

FIG. 5 is a diagram that illustrates how embodiments of the present disclosure can prevent focus from inadvertently changing away from a secure input.

FIG. 6 is a diagram illustrating how a secure input can be emphasized, in accordance with an embodiment of the present disclosure.

FIG. 7 is a block diagram of a computing device that can prevent focus from changing away from a secure input, in accordance with an embodiment of the present disclosure.

FIG. 8 is a sequence diagram showing interactions that can occur within a computing device configured to prevent focus from changing away from a secure input, in accordance with an embodiment of the present disclosure.

FIG. 9 is a flow diagram of an illustrative process for enabling a focus lock on a secure input, in accordance with an embodiment of the present disclosure.

FIG. 10 is a flow diagram of an illustrative process for emphasizing a secure input, in accordance with an embodiment of the present disclosure.

### DETAILED DESCRIPTION

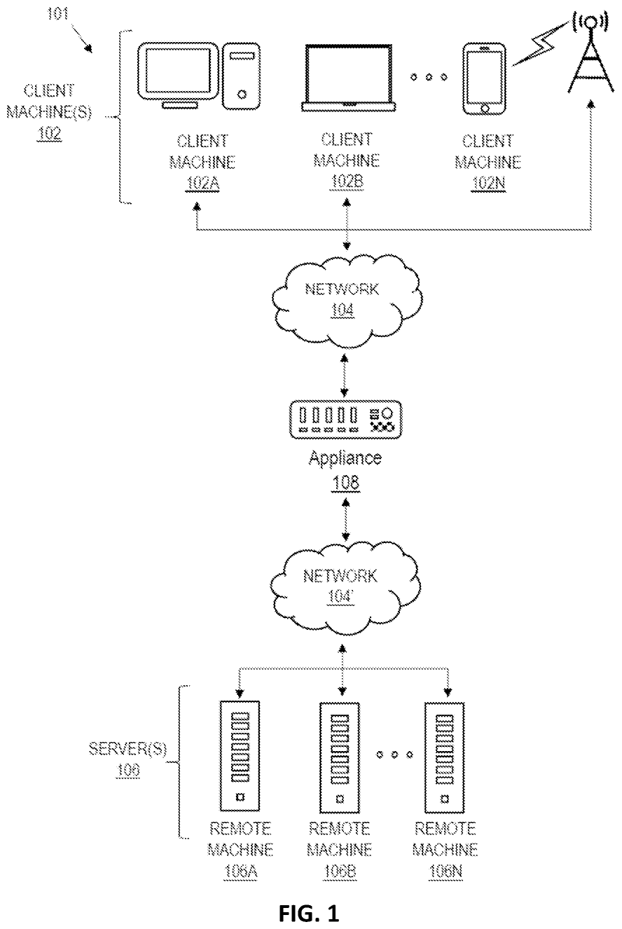

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

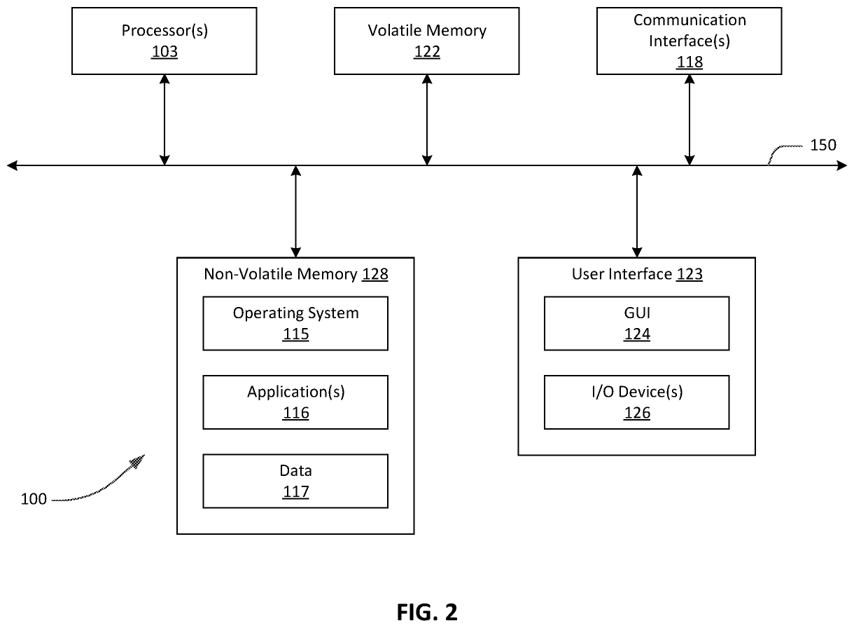

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (CPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

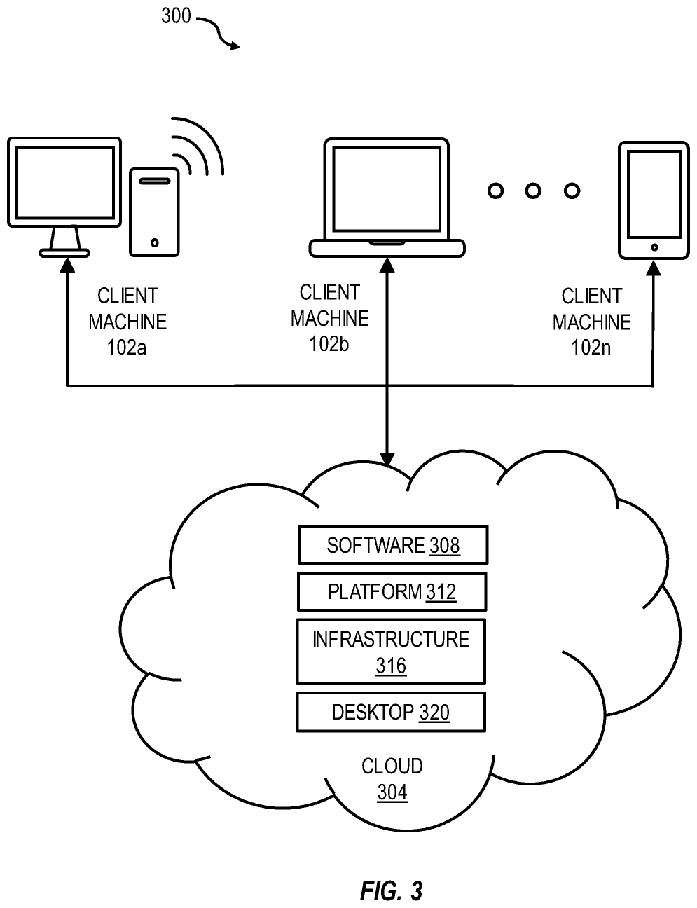

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, California, or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

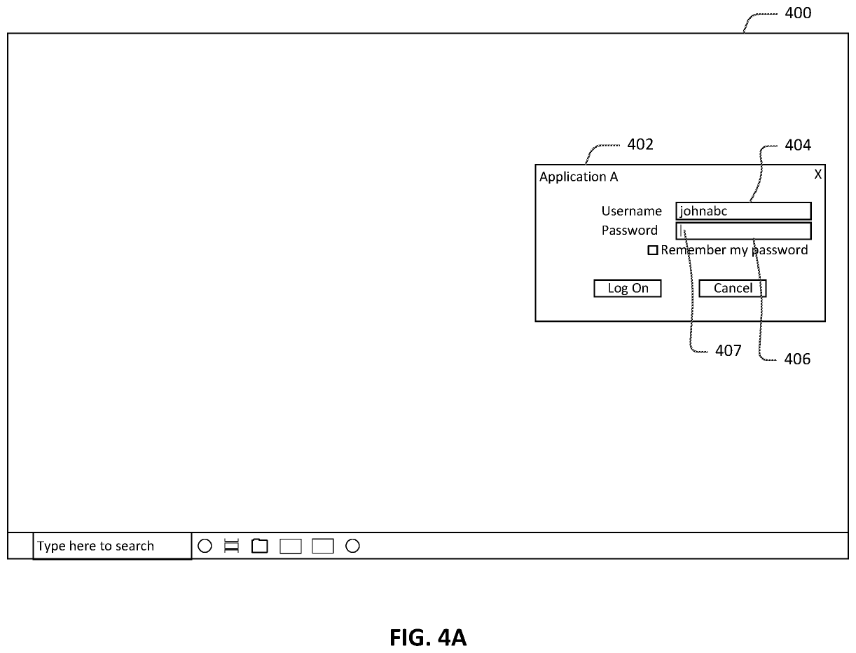

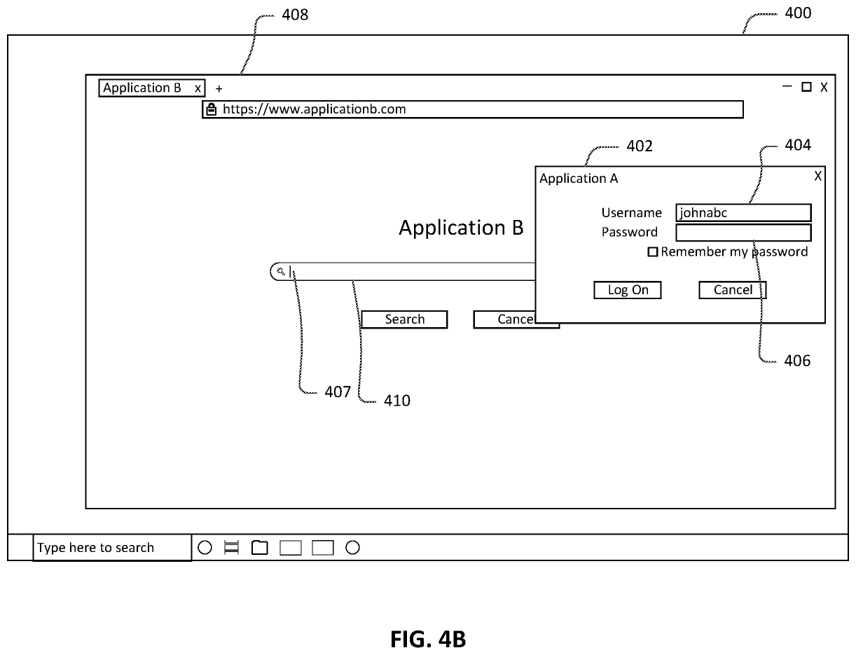

FIGS. 4A and 4B collectively illustrate how focus can inadvertently change away from a secure input as a result of an application window opening. As illustrated in FIG. 4A, an application (e.g., an “Application A”) may display a window 402 within a graphical user interface (GUI) 400 of a computing device when its user attempts to access the application. For example, Application A may display window 402 to allow the user to login to Application A. Window 402 may include a username input (or “username field”) 404 for entering a username and a password input (or “password field”) 406 for entering a password. To enter a username, the user can tab to or click on username input 404 using a mouse to activate username input 404 to receive input. Tabbing or clicking on username input 404 causes username input 404 to obtain focus. Upon entering a username (e.g., “johnabc” as shown in FIG. 4A), the user can press the tab key, click/tap on password input 406 using a mouse/touchscreen, or otherwise perform some action to cause the focus to change from username input 404 to password input 406. A cursor 407 (e.g., a blinking solid vertical line) may display in password input 406 as a visual indication that password input 406 has obtained the focus and is active for receiving input. Password input 406 may be configured to obfuscate characters entered therein, for example by replacing each entered character with a dot or star. In contrast, username input 404 may display the characters entered therein without obfuscation. For example, if Application A is a web application, password input 406 may be defined as an <input type=“password” . . . >whereas username input 404 may be defined as an <input type=“text” . . . >. GUI 400 may correspond to a desktop computing environment such as WINDOWS, MACOS, CHROMEOS, etc. or MACOS, or to a mobile or tablet graphical computing environment such as IOS, ANDROID, etc.

Turning to FIG. 4B, before the user starts entering a password (or as the user is entering a password) into Application A, another application (e.g., an “Application B”) may open a window 408 within GUI 400 of the computing device. Application B may be, for example, a web browser accessing a search engine web page, as illustrated in FIG. 4B. Application B may include one or more UI elements that are capable of receiving focus, such as search input (or “search field”) 410. Since window 408 is a newly opened window, window 408 obtains the focus, and password input 406 no longer has focus. In other words, upon window 408 being opened within GUI 400, focus may change from password input 406 of Application A to search input 410 of Application B. The focus may change automatically by operation of the GUI 400. As can be seen in FIG. 4B, cursor 407 may now display in search input 410 as a visual indication that search input 410 has obtained the focus and thus will receive any subsequent user input (e.g., characters entered by the user). Such automatic change of focus can result in an inadvertent disclosure of the user's password. For example, the user may believe that they are that they are entering the password into password input 406 of Application A when, in fact, the user is inadvertently entering their password, or a portion thereof, within search input 410 of Application B. If search input 410 is not configured to hide/obfuscate characters entered therein, then the user's password may be clearly visible (or “leaked”) on the computing device's display. Moreover, if the user presses the enter/return key (e.g., thinking they are submitting their username and password to Application A), then the user's password entered within search input 410 may be transmitted to an untrusted server device associated with Application B.

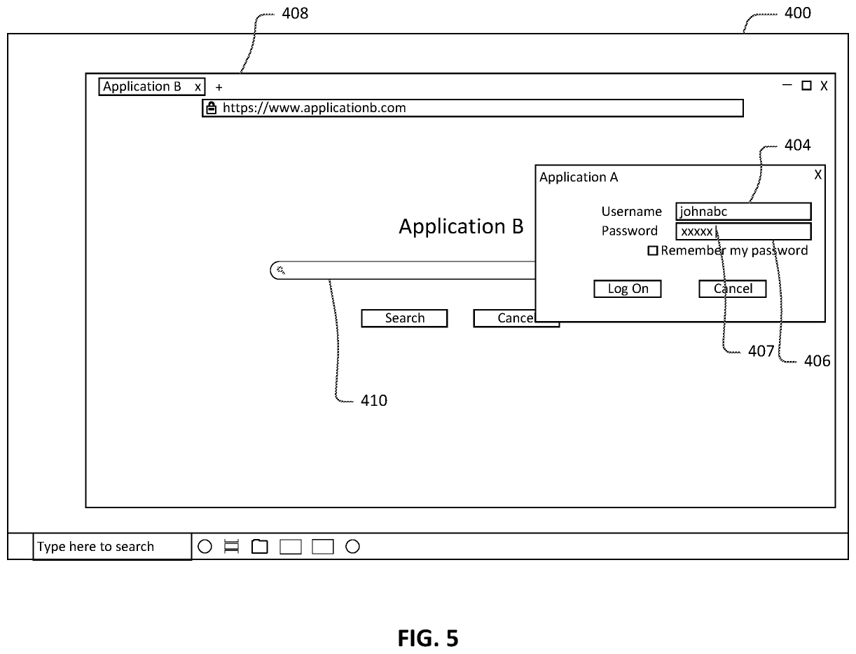

FIG. 5 illustrates how embodiments of the present disclosure can prevent focus from inadvertence changing away from a password input or other secure input. As shown, windows 402 and 408 illustrated in FIG. 5 are similar to windows 402 and 408 illustrated in FIG. 4B, except that the focus does not change away from password input 406 when window 408 is opened within GUI 400 of the computing device. In other words, password input 406 does not lose the focus when Application B opens window 408 on the computing device.

To achieve this, in some embodiments, the computing device is programmed or otherwise configured to (includes an application that is configured to) determine whether a UI element that currently has focus is a secure input (e.g., a password field). A secure input refers to a focusable UI element that a user can interact with to enter secure data such as a password or other sensitive or secure information. In some cases, a secure input may be a type of input that hides/obfuscates characters entered thereinto. In some such embodiments, the computing device can prevent the focus from changing away from a UI element in response to a determination that the UI element that currently has focus is a secure input.

Referring again to the example of FIG. 5, the computing device can determine that password input 406 currently has focus. The computing device can also determine that password input 406 is a secure input since password input 406 is for entering a password. In this case, the computing device can prevent the focus from changing away from password input 406. For example, the computing device can prevent the focus from changing away from password input 406 even when a new window (e.g., window 408) is opened on the computing device. As can be seen in FIG. 5, upon window 408 being opened within GUI 400 of the computing device, cursor 407 remains displayed in password input 406, and does not move to search input 410, as a visual indication that the focus has not changed from password input 406.

In some embodiments, the computing device can allow the focus to change away from a secure input in response to a determination that the input to the secure input (e.g., password input 406) is complete. For example, the user can perform an action and/or interaction with a UI, such as, for example, pressing the tab key or clicking on a different UI element, pressing or otherwise activating an enter/return key, or clicking on a log on button or UI control, among others, to signal or indicate the end or completion of the interaction (e.g., input) to the secure input. Thus, once the computing device prevents the focus from changing away from a UI element, the focus may move to a different UI element in response to a user action and/or interaction with the UI of the computing device but not automatically as a result of a new window opening on the computing device.

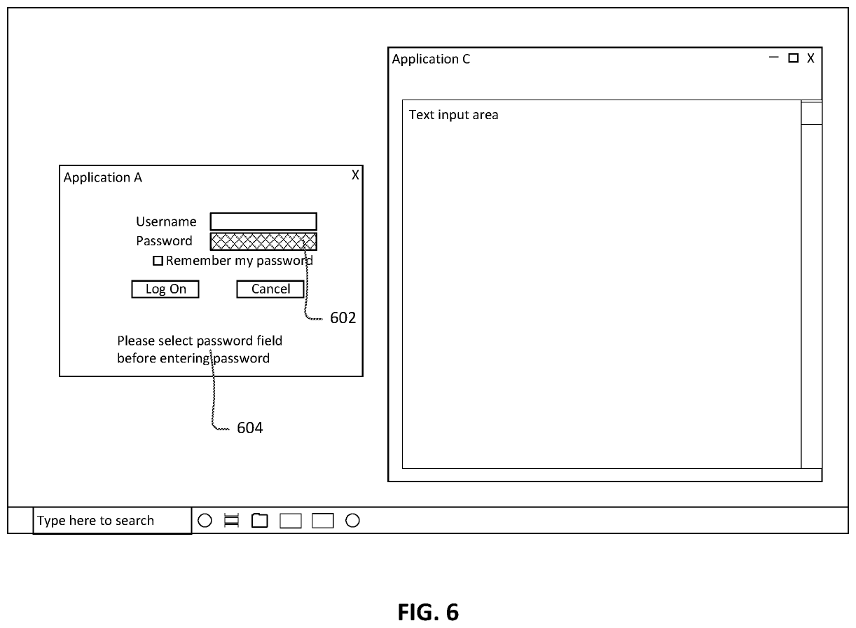

FIG. 6 illustrates how embodiments of the present disclosure can automatically identify and emphasize secure inputs such that they are more conspicuous to users. In more detail, a computing device can be programmed or otherwise configured to identify which UI elements of applications running on the computing device are secure inputs, and to emphasize such UI elements such that the emphasized UI elements are more conspicuous than they would otherwise be. Emphasizing a secure input in this manner provides a visual indication to a user that the emphasized UI element is a secure input. For example, as shown in FIG. 6, the computing device can determine that Application A and Application C are running on the computing device and identify a UI element 602 of Application A as a secure input since UI element 602 is for entering a password. For example, UI element 602 may be for entering a password of a user credential for logging in to Application A.

In response to identifying UI element 602 as a secure input, the computing device can emphasize UI element 602 (as illustrated with cross-hatched lines in FIG. 6). For example, the emphasizing of a UI element can include changing the background color of the UI element (e.g., to bright yellow or another color conventionally used for highlighting purposes), adding a border around UI element or changing the color of an existing border, changing a label associated with the UI element to a different font, font size, and/or color, or some combination thereof, to provide a few examples.

While only one emphasized secure input is illustrated in FIG. 6 for purposes of clarity, it will be appreciated that there may be other secure inputs that are also emphasized by the computing device. For example, Application C or a different application that is running on the computing device may also have a secure input. In such cases, the computing device can similarly identify and emphasize the secure input of Application C or the different application that is running on the computing device.

In some embodiments, the computing device may display a message as a further visual indication of the identified secure input. The displayed message may alert the user to check that the secure input is active for receiving input before entering or otherwise providing the secure input (e.g., sensitive information). For example, as shown in FIG. 6, the computing device can display a message 604 as a visual indication of UI element 602, which is identified as a secure input. As can be seen in FIG. 6, message 604 can alert a user to “Please select password field before entering password.” The computing device can display message 604 in the same window in which the associated secure input (e.g., UI element 602) is displayed.

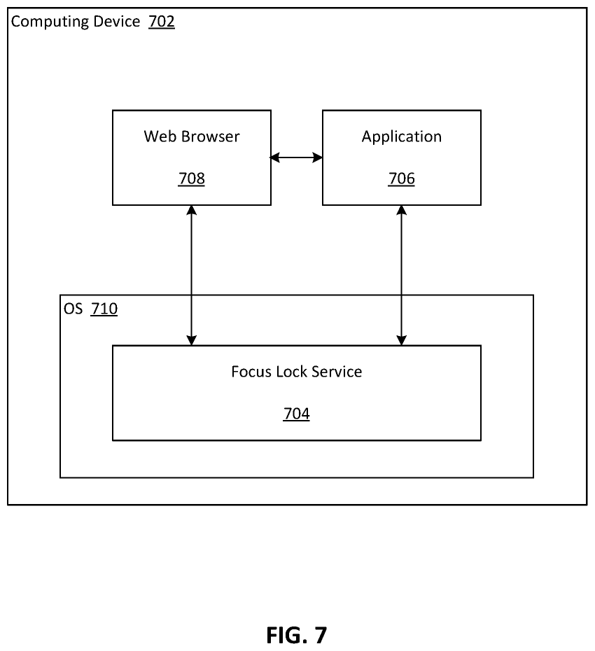

FIG. 7 shows a computing device 702 in which a focus lock service 704 can provide a focus lock feature, in accordance with an embodiment of the present disclosure. In brief, focus lock service 704 can be understood as providing a focus lock feature on computing device 702. The focus lock feature can be enabled or disabled on computing device 702, for example, by a user of computing device 702. When the focus lock feature is enabled, a focus lock may be enabled on a UI element (e.g., a secure input). When the focus lock is enabled on a UI element (e.g., a secure input), the focus is prevented from changing away from the UI element except in response to a user action and/or interaction with a UI on computing device 702. Thus, when this feature is enabled, a new window (e.g., an application window) opening on computing device 702 does not cause the focus to change away (i.e., move away) from the UI element which currently has focus and on which the focus lock is enabled.

In some embodiments, focus lock service 704 may provide emphasizing of the secure inputs of applications that are running on computing device 702. The emphasizing of the secure inputs may allow for easier recognition of the secure inputs by a user of computing device 702. In some such embodiments, the emphasizing of the secure inputs may be provided when the focus lock feature is enabled. In other embodiments, the emphasizing of the secure inputs may be provided independent of the focus lock feature. For example, the emphasizing of the secure inputs may be provided as a secure input highlighting feature that can be enabled or disabled on computing device 702, for example, by a user of computing device 702.

In some embodiments, computing device 702 may form part of a network environment, such as network environment 101 of FIG. 1. For example, computing device 702 of FIG. 7 may correspond to client machine 102 described above in the context of FIG. 1.

In some embodiments, computing device 702 may form part of a cloud computing environment, such as cloud computing environment 300 of FIG. 3. For example, computing device 702 of FIG. 7 may correspond to client 102 described above in the context of FIG. 3.

Computing device 702 may include desktop computers, laptop computers, workstations, handheld computers, tablet computers, mobile devices, smartphones, and any other machine configured to install and run applications (or “apps”) such as for example, one or more applications 706. For example, applications 706 may include web apps and websites, and computing device 702 can have installed a web browser 708 for accessing and interacting with applications 706. Computing device 702 can include other hardware and software components such as those described above in the context of computing device 100 of FIG. 2.

Still referring to computing device 702, in some embodiments, focus lock service 704 can be included in or otherwise provided as a component of an operating system (OS) 710 of computing device 702. In such implementations, the focus lock feature provided by focus lock service 704 can be accessed as part of the system settings on computing device 702. For example, a user can access the system settings of computing device 702 and enable or disable the focus lock feature on computing device 702.

When the focus lock feature is enabled, focus lock service 704 can monitor input events on computing device 702 as a user uses web browser 708 to interact with various applications 706 (e.g., web apps and websites), for example. For example, focus lock service 704 can use an API provided by web browser 708 to attach event listeners to various UI elements, such as text fields, text boxes, and other focusable UI elements configured to receive input (e.g., text input), to detect user interaction with the UI elements. Upon detecting user interaction with such a UI element (i.e., a UI element to which an event listener is attached), focus lock service 704 can determine whether the interacted UI element has focus. For example, focus lock service 704 can use an API provided by OS 710 (e.g., UlElement.IsKeyboardFocused Property in Windows® to determine whether the UI element has focus. For instance, in Windows®, the UI element with focus has IsKeyboardFocused property set to TRUE. If focus lock service 704 determines that the interacted UI element has focus, focus lock service 704 can determine whether this UI element is a secure input. For example, focus lock service 704 can make this determination from or using one or more attributes defined for the UI element, such as an “id,” “name,” or “label” attribute. By way of an example, a UI element having an “id”, “name”, or “label” attribute “password”, “social security number”, “account number”, or variants thereof, to provide a few examples, may be a secure input.

If focus lock service 704 determines that the interacted UI element is a secure input, focus lock service 704 can enable the focus lock on the secure input to prevent the focus from changing away (i.e., moving away) from the secure input. For example, focus lock service 704 can monitor the focus to detect an attempt to change or otherwise move the focus away from the secure input. Upon detecting such an attempt, focus lock service 704 can prevent the focus from changing away from the secure input. For instance, in an example implementation, focus lock service 704 can prevent the IsKeyboardFocused property of the secure input from being set to or otherwise becoming FALSE.

Otherwise, if focus lock service 704 determines that the interacted UI element does not have focus, focus lock service 704 does not check to determine whether this UI element is a secure input. In some embodiments, focus lock service 704 may continue to monitor input events on computing device 702 since the focus lock feature is enabled, for example.

In some embodiments, focus lock service 704 can maintain the focus lock on a secure input until the user completes his/her interaction with the secure input. For example, upon enabling the focus lock, focus lock service 704 can continue to monitor the user's interaction with the secure input. Based on the monitoring, focus lock service 704 can determine when the user completes interacting with the secure input. For example, actions such as tabbing to or clicking on a different UI element, pressing or otherwise activating an enter/return key, or clicking on a log on button or UI control, among others, may indicate a completion of the interaction with the secure input. Upon detecting the completion of the interaction with the secure input, focus lock service 704 can disable the focus lock. Disabling the focus lock allows the focus lock to change away (i.e., move away) from the secure input. In some embodiments, focus lock service 704 may continue to monitor input events on computing device 702 since the focus lock feature is enabled, for example.

In some embodiments, focus lock service 704 can provide a secure input highlighting feature which can be enabled or disabled on computing device 702. When this feature is enabled, focus lock service 704 can monitor for applications running on computing device 702. For example, focus lock service 704 can listen for browser navigation events (e.g., webNavigation events) to detect when the current page URL changes. As another example, focus lock service 704 can monitor various elements of the Document Object Model (DOM) and detect when a user clicks, taps, or otherwise interacts with UI elements. As still another example, focus lock service 704 can generate a hook procedure (e.g., a process and/or thread creation API hook such as a CreateProcess function on WINDOWS or fork function on Linux or MACOS) to monitor for API calls related to the opening of web apps and websites. In any such cases, focus lock service 704 can detect an application that is running (e.g., an application that starts running) on computing device 702.

Upon detecting an application running on computing device 702, focus lock service 704 can identify the UI elements within the application's UI (e.g., the application's window). For example, focus lock service 704 can scan the UI data representative of the application's UI to identify the UI elements of the application. Focus lock service 704 can then determine whether any of the UI elements is a secure input. For example, as described above, focus lock service 704 can make this determination from or using one or more attributes defined for the UI element, such as an “id,” “name,” or “label” attribute. For each individual UI element that is a secure input, focus lock service 704 can emphasize the UI element to make the UI element more conspicuous to the user. For example, focus lock service 704 can emphasize the UI element by changing a background color of the UI element, adding/changing a border of the UI element, displaying a label of the UI element in a different font, font size, and/or color, or some combination thereof, to provide a few examples.

In some embodiments, focus lock service 704 can display a message as a visual indication of the secure input. The displayed message can alert a user of the presence of the secure input and remind the user to check that the secure input is active for receiving input prior to entering or otherwise providing the secure input.

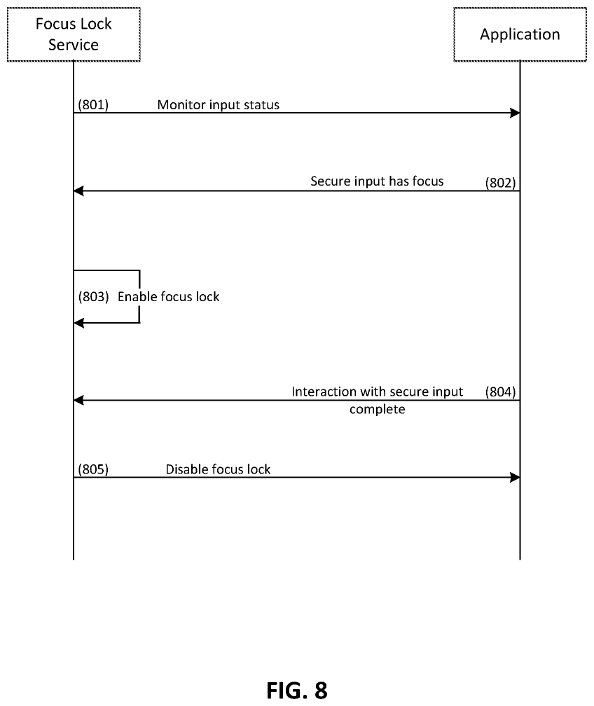

FIG. 8 is a sequence diagram showing an example flow of interactions between various components to enable a focus lock, in accordance with an embodiment of the present disclosure. For example, with reference to the elements illustrated in FIG. 7, a user may be using web browser 708 running on computing device 702 to access and interact with application 706. Prior to or during access of application 706, the user may have enabled the focus lock feature provided by focus lock service 704 on computing device 702. When this feature is enabled, focus lock service 704 may monitor (802) input status of application 706 to determine whether a secure input has focus. For example, to monitor the input status, focus lock service 704 can use event listeners to detect the user's interaction with the UI elements of application 706. Upon detecting the user's interaction with a UI element, focus lock service 704 can determine whether the interacted UI element has focus and, if so, further determine whether the interacted UI element is a secure input. It will be appreciated that the order of the checks (e.g., determining whether the interacted UI element has focus and determining whether the interacted UI element is a secure input) can be performed in any order. If it is determined that the interacted UI element does not have focus or the interacted UI element has focus but is not a secure input, focus lock service 704 can continue to monitor the input status of application 706.

Otherwise, based on the checks, focus lock service 704 can determine (804) that the UI element that has focus is a secure input. In other words, monitoring of the input status of application 706 may indicate that the UI element that the user is interacting with has focus and that the interacted UI element is a secure input. Upon determining that the UI element that has focus is a secure input, focus lock service 704 can enable (803) the focus lock on the secure input. Enabling the focus lock prevents the focus from changing away (i.e., moving away) from the secure input, which is the UI element of application 706 that the user is interacting with.

Focus lock service 704 can then receive (804) an indication from application 706 or otherwise determine that the user has completed the interaction with the secure input. For example, the user may tab or click on another different UI element of application 706 or a different UI element of another application to interact with that different UI element. Upon determining that the user has completed interacting with the secure input, focus lock service 704 can disable (805) the focus lock on the secure input. As a result, the focus can change away from the secure input of application 706 that the user completed interacting with. When the focus lock is disabled, the focus may be obtained by (i.e., move to) a different UI element of application 706 or a UI element of a different application running on computing device 702. For example, the focus can move to the other UI element that the user tabbed on indicate completion of the user's interaction with the secure input of application 706.

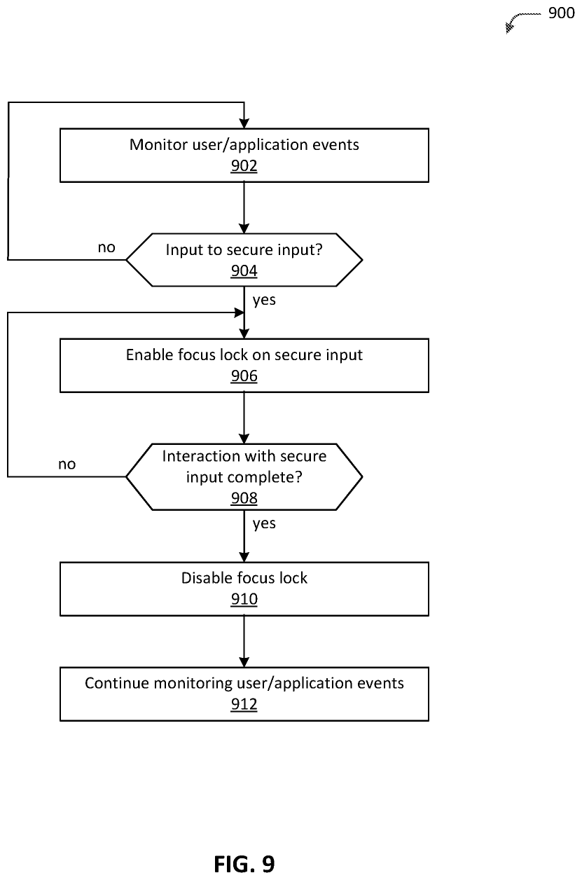

FIG. 9 is a flow diagram of an illustrative process 900 for enabling a focus lock on a secure input, in accordance with an embodiment of the present disclosure. For example, process 900, and process 1000 further described below, may be implemented or used within a computing environment or system such as those disclosed above at least with respect to FIG. 1, FIG. 2, FIG. 3, and/or FIG. 7. For example, in some embodiments, the operations, functions, or actions illustrated in example process 900, and example process 1000 further described below, may be stored as computer-executable instructions in a computer-readable medium, such as volatile memory 122 and/or non-volatile memory 128 of computing device 100 of FIG. 2 (e.g., computer-readable medium of client machines 102 of FIG. 1, client machines 102a-102n of FIG. 3, and/or computing device 702 of FIG. 7). For example, the operations, functions, or actions described in the respective blocks of example process 900, and example process 1000 further described below, may be implemented by operating system 115, applications 116, and/or data 117 of computing device 100.

With reference to illustrative process 900 of FIG. 9, illustrative process 900 may be implemented within a focus lock service (e.g., focus lock service 704 of FIG. 7) on a computing device. At 902, the focus lock service can monitor user and application events on the computing device. For example, the user and application events on the computing device can be monitored when a focus lock feature is enabled on the computing device. At 904, the focus lock service can monitor for an input event to a secure input (e.g., a password field) of an application running on the computing device. For example, event listeners attached to UI elements, OS API calls, and/or attributes of the UI elements can be utilized to monitor for an input event to a secure input.

If an input event to a secure input is not detected, the focus lock service can continue to monitor (at 902) the user and application events on the computing device for an input event to a secure input. For example, the monitoring may can be continued until the focus lock feature on the computing device is disabled.

Otherwise, if an input event to a secure input is detected, then, at 906, the focus lock service can enable the focus lock on the secure input. For example, the focus lock may be enabled on the secure input by preventing the IsKeyboardFocused property of the secure input to be set to or otherwise becoming FALSE.

At 908, the focus lock service can determine whether the interaction with the secure input is complete. For example, the determination of whether the interaction with the secure input is complete may be made from user action and/or interaction with the secure input or another UI element. If the interaction with the secure input is not complete, the focus lock service can maintain (at 906) the focus lock on the secure input and monitor (at 908) for completion of the interaction with the secure input.

Otherwise, if the interaction with the secure input is complete, then at 910, the focus lock service can disable the focus lock which was enabled on the secure input. For example, the focus lock may be disabled by allowing (e.g., no longer preventing) the IsKeyboardFocused property of the secure input to be set to or otherwise becoming FALSE. At 912, the focus lock service can continue with the monitoring of user and application events on the computing device.

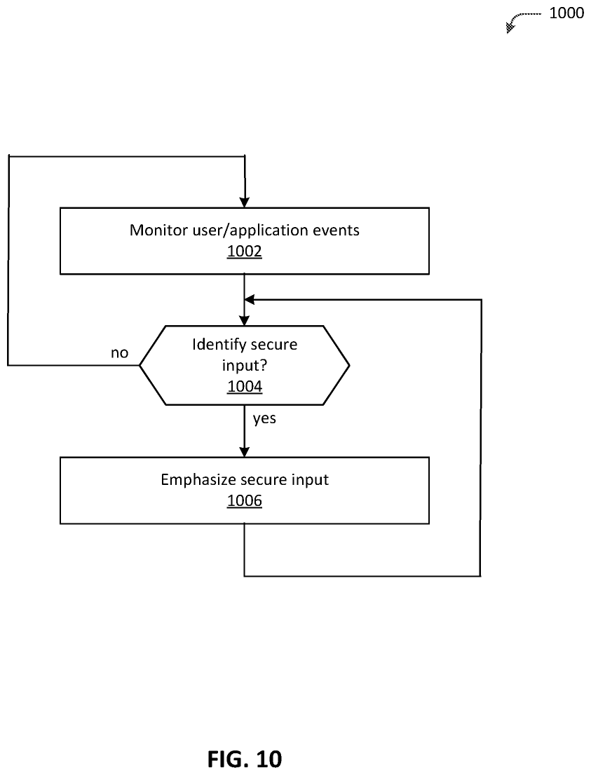

FIG. 10 is a flow diagram of an illustrative process 1000 for emphasizing a secure input, such as a password field or other UI element, in accordance with an embodiment of the present disclosure. Illustrative process 1000 may be implemented by a focus lock service on a computing device. At 1002, the focus lock service can monitor user and application events on the computing device. For example, in an implementation, the user and application events on the computing device can be monitored for applications running on the computing device when a secure input highlighting feature is enabled on the computing device.

At 1004, the focus lock service can monitor for a secure input (e.g., a password field) within a UI of an application that is running on the computing device. For example, event listeners, DOM elements, hook procedures, and/or UI data can be utilized to monitor for the presence of a secure input. If a secure input is not identified (e.g., a UI of a running application does not include a password field), the focus lock service can continue to monitor (at 1002) the user and application events on the computing device for applications running on the computing device.

Otherwise, if a secure input is identified (e.g., a UI of a running application includes a password field), then, at 1006, the focus lock service can emphasize the secure input. For example, focus lock service can emphasize the UI element by changing a color of the UI element to make the UI element more conspicuous to a user when displayed on a screen of the computing device. In some embodiments, the focus lock service can display a message to further alert the user of the presence of the secure input. The focus lock service can then check (at 1004) for other secure inputs within the UI of the application that is running on the computing device.

### Further Example Embodiments

The following examples pertain to further embodiments, from which numerous permutations and configurations will be apparent.

Example 1 includes a method including: determining, by a computing device, whether a user interface element having focus is a secure input; and, responsive to a determination that the user interface element is a secure input: preventing, by the computing device, the focus from changing away from the user interface element; and responsive to a determination that an input to the user interface element is complete, allowing, by the computing device, the focus to change away from the user interface element.

Example 2 includes the subject matter of Example 1, further including, responsive to a determination that the user interface element is not a secure input, allowing, by the computing device, the focus to be moved to another user interface element.

Example 3 includes the subject matter of Example 2, wherein the user interface element is included in a window and the another user interface element is included in another window that is different than the window.

Example 4 includes the subject matter of any of Examples 1 through 3, wherein the determination that an input to the user interface element is complete is based on detecting a user interaction with the user interface element.

Example 5 includes the subject matter of any of Examples 1 through 3, wherein the determination that an input to the user interface element is complete is based on detecting a user interaction with another user interface element that is different than the user interface element.

Example 6 includes the subject matter of Example 5, wherein the user interface element is included in a window and the another user interface element is included in another window that is different than the window.

Example 7 includes the subject matter of any of Examples 1 through 6, wherein the user interface element is a password input.

Example 8 includes the subject matter of any of Examples 1 through 7, further including, responsive to the determination that the user interface element is a password input, emphasizing, by the computing device, the user interface element.

Example 9 includes the subject matter of any of Examples 1 through 8, further including: identifying, by the computing device, one or more applications executing on the computing device; identifying, by the computing device, one or more user interface elements associated with the identified one or more applications which are password inputs; and emphasizing, by the computing device, the identified one or more user interface elements.

Example 10 includes a system including a memory and one or more processors in communication with the memory and configured to: determine whether a user interface element having focus is a secure input; and, responsive to a determination that the user interface element is a secure input: prevent the focus from changing away from the user interface element; and, responsive to a determination that an input to the user interface element is complete, allowing, by the computing device, the focus to change away from the user interface element.

Example 11 includes the subject matter of Example 10, wherein the one or more processors are further configured to, responsive to a determination that the user interface element is not a secure input, allow the focus to be moved to another user interface element.

Example 12 includes the subject matter of Example 11, wherein the user interface element is included in a window and the another user interface element is included in another window that is different than the window.

Example 13 includes the subject matter of any of Examples 10 through 12, wherein the determination that an input to the user interface element is complete is based on detecting a user interaction with the user interface element.

Example 14 includes the subject matter of any of Examples 10 through 12, wherein the determination that an input to the user interface element is complete is based on detecting a user interaction with another user interface element that is different than the user interface element.

Example 15 includes the subject matter of Example 14, wherein the user interface element is included in a window and the another user interface element is included in another window that is different than the window.

Example 16 includes the subject matter of any of Examples 10 through 15, wherein the user interface element is a password input.

Example 17 includes the subject matter of any of Examples 11 through 16, wherein the one or more processors are further configured to, responsive to the determination that the user interface element is a password input, emphasize the user interface element.

Example 18 includes the subject matter of any of Examples 11 through 17, wherein the one or more processors are further configured to: identify one or more applications executing on the computing device; identify one or more user interface elements associated with the identified one or more applications which are password input; and emphasize the identified one or more user interface elements.

Example 19 includes a method including: identifying, by a computing device, one or more applications executing on the computing device; identifying, by the computing device, one or more user interface elements associated with the identified one or more applications which are secure inputs; and emphasizing, by the computing device, the identified one or more user interface elements.

Example 20 includes the subject matter of Example 19, wherein at least one of the one or more user interface elements is a password input.

Example 21 includes a system including a memory and one or more processors in communication with the memory and configured to: identify one or more applications executing on the computing device; identify one or more user interface elements associated with the identified one or more applications which are secure inputs; and emphasize the identified one or more user interface elements.

Example 22 includes the subject matter of Example 21, wherein at least one of the one or more user interface elements is a password input.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
determining, by a computing device, whether a user interface element having focus is a secure input; and
responsive to a determination that the user interface element is a secure input:
preventing, by the computing device, the focus from changing away from the user interface element; and
responsive to a determination that an input to the user interface element is complete, allowing, by the computing device, the focus to change away from the user interface element.

2. The method of claim 1, further comprising, responsive to a determination that the user interface element is not a secure input, allowing, by the computing device, the focus to be moved to another user interface element.

3. The method of claim 2, wherein the user interface element is included in a window and the another user interface element is included in another window that is different than the window.

4. The method of claim 1, wherein the determination that an input to the user interface element is complete is based on detecting a user interaction with the user interface element.

5. The method of claim 1, wherein the determination that an input to the user interface element is complete is based on detecting a user interaction with another user interface element that is different than the user interface element.

6. The method of claim 5, wherein the user interface element is included in a window and the another user interface element is included in another window that is different than the window.

7. The method of claim 1, wherein the user interface element is a password input.

8. The method of claim 1, further comprising, responsive to the determination that the user interface element is a password input, emphasizing, by the computing device, the user interface element.

9. The method of claim 1, further comprising:
identifying, by the computing device, one or more applications executing on the computing device;
identifying, by the computing device, one or more user interface elements associated with the identified one or more applications which are password inputs; and
emphasizing, by the computing device, the identified one or more user interface elements.

10. A system comprising:
a memory; and
one or more processors in communication with the memory and configured to:
determine whether a user interface element having focus is a secure input; and
responsive to a determination that the user interface element is a secure input:
prevent the focus from changing away from the user interface element; and
responsive to a determination that an input to the user interface element is complete, allowing, by the computing device, the focus to change away from the user interface element.

11. The system of claim 10, wherein the one or more processors are further configured to, responsive to a determination that the user interface element is not a secure input, allow the focus to be moved to another user interface element.

12. The system of claim 11, wherein the user interface element is included in a window and the another user interface element is included in another window that is different than the window.

13. The system of claim 10, wherein the determination that an input to the user interface element is complete is based on detecting a user interaction with the user interface element.

14. The system of claim 10, wherein the determination that an input to the user interface element is complete is based on detecting a user interaction with another user interface element that is different than the user interface element.

15. The system of claim 14, wherein the user interface element is included in a window and the another user interface element is included in another window that is different than the window.

16. The system of claim 10, wherein the user interface element is a password input.

17. The system of claim 10, wherein the one or more processors are further configured to, responsive to the determination that the user interface element is a password input, emphasize the user interface element.

18. The system of claim 10, wherein the one or more processors are further configured to:
identify one or more applications executing on the computing device;
identify one or more user interface elements associated with the identified one or more applications which are password inputs; and
emphasize the identified one or more user interface elements.

19. A method comprising:
identifying, by a computing device, one or more applications executing on the computing device;
identifying, by the computing device, one or more user interface elements associated with the identified one or more applications which are secure inputs; and
emphasizing, by the computing device, the identified one or more user interface elements.

20. The method of claim 19, wherein at least one of the one or more user interface elements is a password input.
